(19) United States
(12) Patent Application Publication
(10) Pub. No.: US 2021/0227935 A1
(43) Pub. Date: Jul. 29, 2021

(54) ARTICLE OF FOOTWEAR

(71) Applicant: Under Armour, Inc., Baltimore, MD (US)

(72) Inventors: James Webster, Baltimore, MD (US); Thomas White, Baltimore, MD (US); Kevin Fallon, Portland, OR (US)

(21) Appl. No.: 17/230,259

(22) Filed: Apr. 14, 2021

Related U.S. Application Data
(62) Division of application No. 15/347,589, filed on Nov. 9, 2016.
(60) Provisional application No. 62/252,728, filed on Nov. 9, 2015.

(51) Int. Cl. A43B 23/02; D06N 3/00; B29D 35/12; B32B 3/26; B32B 3/30; B32B 25/02

(52) U.S. Cl. CPC A43B 23/026; A43B 23/028; D06N 3/0004; A43B 23/027; B29D 35/126; B29K 2007/00; B32B 3/26; B32B 3/30; B32B 25/02; B32B 2307/50; A43B 23/0235

(57) ABSTRACT

A method of forming a shoe upper includes obtaining a mold defining a shoe component, spraying a polymer formulation onto the mold to form a sprayed polymer formulation layer, curing the sprayed polymer formulation layer to form a polymer film, removing the film from the mold, and incorporating the film into the shoe upper.

### CROSS REFERENCE TO RELATED APPLICATIONS

The present application is a divisional of U.S. patent application Ser. No. 15/347,589, filed Nov. 9, 2016 and entitled “Article of Footwear”, which claims priority from U.S. Provisional Patent Application Ser. No. 62/252,728; filed Nov. 9, 2015 and entitled “Article of Footwear,” the disclosures of which are incorporated herein by reference in their entireties.

### FIELD OF THE INVENTION

The present invention relates to articles of footwear and, in particular, to footwear uppers.

### BACKGROUND OF THE INVENTION

In conventional footwear, layers of fabric are adhered together. The fabric is created and then cut from a sheet, resulting in a substantial amount of waste. It would be beneficial desirable to provide an article of footwear that does not suffer from these disadvantages.

### BRIEF SUMMARY OF THE INVENTION

The present invention is generally directed toward an article of footwear including a sole structure and an upper. The upper is formed of material including an auxetic layer. The auxetic layer defines a plurality of substructures operable to expand and contract when tension is applied and removed, respectively. With this configuration, the auxetic layer is capable of synclastic expansion. The auxetic layer is formed by spraying a polymer onto a mold containing the substructure pattern. In an embodiment, one or more flock layers may be coupled to the auxetic layer. The resulting structure is capable of synclastic expansion.

### BRIEF DESCRIPTION OF THE SEVERAL VIEWS OF THE DRAWINGS

FIG. 1A is a schematic showing a web structure possessing a synclastic stretch pattern in accordance with an embodiment of the invention.

FIG. 1B is schematic of a cell of the pattern of FIG. 1A.

FIG. 1C is schematic of a cell of the pattern of FIG. 1A.

FIG. 1D is the web structure of FIG. 1A, shown in an expanded configuration under tension.

FIG. 2A is a schematic for a mold in accordance with the embodiment of the invention.

FIG. 2B is a top, close-up view of the mold of FIG. 2A, showing the mold in an uncoated state.

FIG. 2C is a top, close-up view of the mold of FIG. 2A, showing the mold in an uncoated state.

FIG. 2D is a cross sectional view of the mold, taken along lines A-A in FIG. 2C.

FIG. 3 is a schematic showing a structure for flock material in accordance with an embodiment of the invention.

FIG. 4 is a schematic showing a structure for flock material in accordance with an embodiment of the invention.

Like numbers have been used to identify like elements throughout the figures.

### DETAILED DESCRIPTION OF THE INVENTION

The article of footwear includes a sole and an upper. The sole may be any conventional sole, including an outsole and midsole. The upper includes a composite film formed of one or more sprayed layers. A sprayed layer is a layer formed via a sprayable polymer formulation, i.e., a polymer applied via a spraying process in which a jet of vapor or finely divided droplets is directed to a surface using a spray nozzle to form a coating on the surface. In an embodiment the sprayable polymer is an aerosol (a colloid suspension of fine solid particles or liquid droplets in a gas such as air). In another embodiment, the sprayable polymer formulation includes polymer droplets or particles in solution (e.g., water). The polymer will coalesce into a continuous film upon evaporation of the solvent (e.g., water).

By way of example, the sprayable polymer formulation is formed via dispersion polymerization, emulsion polymerization, or suspension polymerization. In an embodiment, the polymer formulation is a sprayable elastomer such as a latex formed via emulsion polymerization. In this process, monomers are converted into polymers in an aqueous emulsion system in the presence of emulsion stabilizers and catalyzed by water-soluble radical initiators. By way of example, water, a monomer of low water solubility (e.g. styrene), water-soluble initiator (e.g. persulfate) and surfactant are combined to form a polymer colloid, i.e., a discrete phase of colloidally stable latex particles dispersed in an aqueous continuous phase. The monomer may be a soft monomer (e.g., acrylates, butadiene, ethylene and vinyl versatate) or a hard monomer (e.g., methacrylates, vinyl acetate, styrene and vinyl chloride. In an embodiment, a combination of hard and soft monomers is utilized.

In another embodiment, the sprayable polymer formulation is a sprayable polyurethane (e.g., ELASTOSKIN® and ELASTOLLAN®, available from BASF, Florham Park, N.J.) may be utilized. Alternatively or in addition to, a polyurethane dispersion (a high solids dispersions of polyurethane/polyuria) (e.g., SYNTEGRA®, available from Dow, Midland, Mich.) may be utilized.

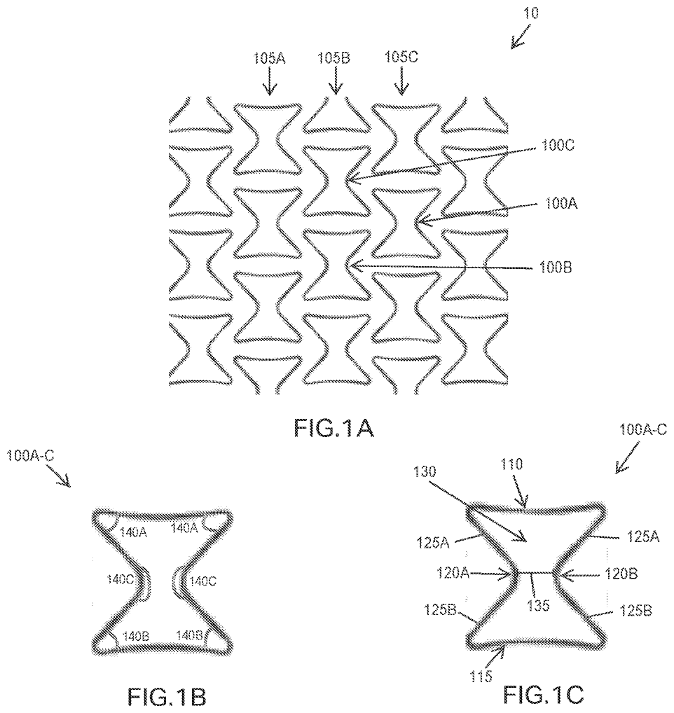

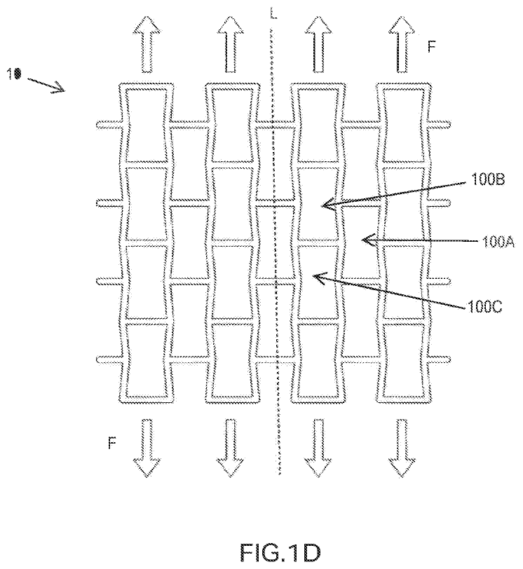

In an embodiment, the functional structures may be incorporated into the composite film. By way of example, the composite film resulting from the sprayed layers has incorporated therein a structure capable of synclastic expansion. By way of example, an auxetic structure may be incorporated into the composite film. Referring to FIG. 1, an auxetic structure includes a framework 10 of substructures 100A, 100B, 100C, with one or more structures within the framework being operable to expand under load from a normal, compact configuration to an expanded or opened configuration. The framework 10 is a unitary or monolithic (one piece) web with substructures 100A, 100B, 100C that are interconnected, sharing borders common with adjacent substructures. With this configuration, the framework 10 is adapted such that movement of one substructure 100A, 100B, 100C generates movement in an adjacent sub structure.

In the illustrated embodiment, the substructures 100A, 100B, 100C are organized in an array having a plurality of columns 105A, 105B, 105C, each column being longitudinally offset from an adjacent column such that substructures 100A-100C of a first column 105A are staggered relative to the substructures of a second, adjacent column 105B. By way of example, the upper end or header of one substructure 100A is oriented proximate the longitudinal center (equator) of its adjacent substructure 100C.

As noted above, each substructure 100A-100C is configured to expand under load from a normal (compact) configuration to an opened (expanded) configuration. Each substructure 100A, 100B, 100C is formed of members or walls movable relative to each other. In the illustrated embodiment, the substructure 100A-100C is a polygon including a header wall 110, a footer wall 115, a first lateral wall 120A with an upper portion 125A and a lower portion 125B, a second lateral wall 120B with an upper portion 125A and a lower portion 125B. The walls cooperate to collectively define a central cell 130. The cell 130 may be unfilled, including no other material therein, or may be closed, including material disposed therein. The upper portions 125A angle inward from the header 110 (into the cell 130). Similarly, the lower portions 125B angle inward from the footer 115. The upper portions 125A intersect the lower portions 125B such that they are aligned across the cell 130, thereby defining a narrowed opening 135.

With this configuration, sides of the polygon—the header 110, the footer 115, the first lateral wall 120A, and the second lateral wall 120B—cooperate to collectively define a plurality of internal angles within the substructure 100A, 100B, 100C. Specifically, the substructure 100A, 100B, 100C includes a first or header angle 140A formed between the header wall 110 and the lateral wall upper portion 125A; a second or footer angle 140B formed between the footer wall 115 and the lateral wall lower portion 125B; and a central angle 140C formed by the upper wall portion 125A and lower wall portion 125B. In an embodiment, in its normal substructure configuration, the header 140A and footer 140B angles are each acute angles (less than 90°) while the central angle 140C is reflexive (possessing a value between 180°-360°).

Each wall of the polygon is configured to pivot along its intersection points. That is, each lateral wall 120A, 120B—each of the upper 125A and lower 125B portions—is capable of moving (e.g., pivoting or flexing) from its normal position (FIG. 1A) to an expanded or opened position. As seen in FIG. 1D, when tension is applied to the framework 10 along its longitudinal axis, the substructures 100A-100C move from their normal orientation to their opened orientation. In the opened orientation, the width of the structure (along the axis generally perpendicular to the longitudinal axis on which tension is applied) widens. Thus, under load, the structure increases in both length and width. Specifically, each substructure 100A-100C is configured to “open up,” moving from its normal, compact position (FIG. 1A) (in which the unit possesses a generally hourglass shape) to its opened, expanded position (FIG. 1D) (in which the unit possesses a generally rectangular shape). As shown, in its normal position, the header angle 140A and footer angle 140B are acute (approximately 45°) and the central angle is reflexive obtuse (approximately 225°). When a load is applied in the length direction/along the longitudinal axis L (indicated by arrow T) lateral walls 120A, 120B are drawn outward, toward the open position. In the open position, the header and footer angles increase, while the central angles CP1, CP2 decrease. In an embodiment, in its opened position, each header angle 140A and footer angle 140B approaches 90° while the central angle 140C approaches 180°.

In order to provide the polygon with its flexure properties—and drive the motion of any layers connected to the auxetic layer when tension is applied—it is necessary to form the polymer framework 10 taking in account the ratio of material mass to the overall size of the substructure and the density of substructures 100A, 100B, 100C within the array. To provide the proper ratio, it is necessary to consider the dimensions of the open space defined by each substructure 100A, 100B, 100C, as well as the height of the material. For example, if the walls 110, 115, 120A, 120B are too thick, they will not flex/rotate. In addition, it is necessary to provide the proper stroke width, the distance traveled by a wall as it moves from its original, normal (compact configuration) to its rotated/flexed position (open configuration), or vice versa. If the stroke width is too short, the units will not cooperate to drive the expansion of the fabric.

By way of example, the ratio of open space height to stroke width ratio may be approximately 2:1-4:1 (e.g., 3:1). Additionally, the open space length may be slightly larger than the open space width measured at its widest point (in the normal position). By way of example, the ratio of open space width to open space length may be approximately 1:1.1-1:1.25. The height (depth) of the units (e.g., of the walls defining the cell 130) is not particularly limited and is generally dependent on the young's modulus of the polymer material.

In forming the composite film including a functional structure, an in-mold coating process may be utilized. In this process, the sprayable polymer is applied to a mold tool possessing the shape of the desired shoe upper component. Once cured, a thin film or skin of polymer is formed on the mold, which is removed upon curing.

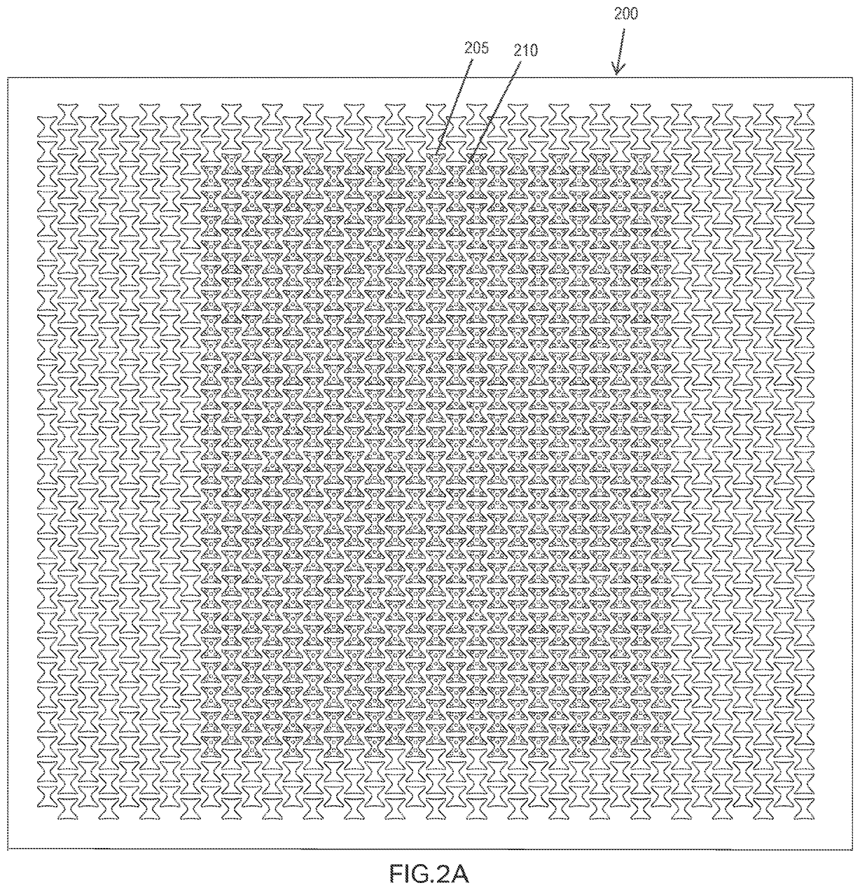

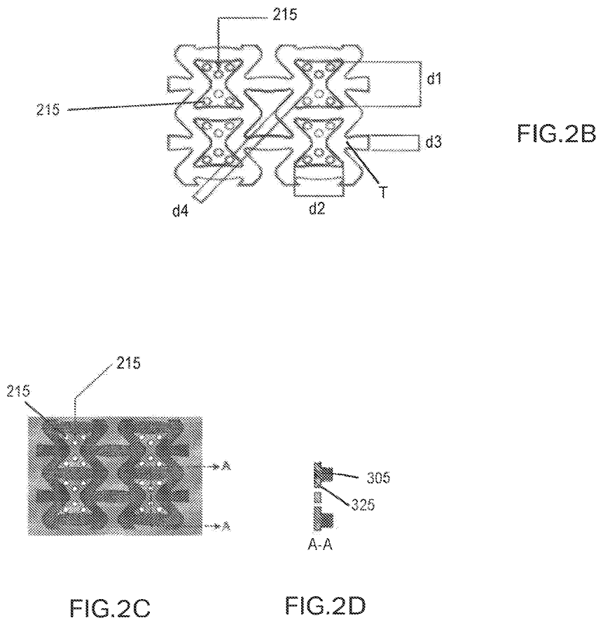

The surface of the mold tool may further include a topology to form the functional structure. As seen in FIG. 2A, the mold 200 includes a topology configured to create the framework 10 interconnected substructures 100A, 100B, 100C. The mold 200 includes a negative of the above-described auxetic framework. Specifically, the mold surface is patterned with an array of cells defined by a central pillars 205 surrounded by interconnected, recessed channels 210 defining the framework 10. The channels are interconnected, being in communication throughout the framework. Optionally, the central pillar 205 may further include perforations 215 to permit the localized draining of the polymer formulation. That is, the polymer formulation will not adhere to the mold at the perforations, creating apertures in the finished material (e.g., air holes to increase the breathability of the upper).

The dimensions of the channels are selected to provide the desired topology of the functional layer. Referring to FIG. 2B, the substructure 100A, 100B, 100C defines a first substructure dimension d1 (height of pillar 205 and, accordingly, the cell 130 of a substructure 100A, 100B, 100C) of approximately 9 mm to 10 mm (e.g., 9.315 mm) and a second substructure dimension d2 (the width of a the upper or lower ends of the pillar and, accordingly, of the resulting substructure cell) of approximately 8-9 mm (e.g., 8.844 mm). A third substructure dimension d3, providing the width of the channel 210 along the header 110 and/or footer 115 may differ from a fourth substructure dimension, representing the width of the channel 210 along the lateral walls 120A, 120B of the substructure 100A, 100B, 100C (e.g., the wall portions 125A, 125B). By way of example, the channel 210 forming the header wall 110 and footer wall 115 may possess a width of approximately 2.5 mm-3.5 mm (e.g., 3 mm), while the channel 210 forming the lateral side walls 120A, 120B may possess a thickness of 1.5 mm-2.5 mm (e.g., 2 mm). In addition, the wall may taper inward as it approaches an angle (e.g., along area T).

It should be understood, however, the channel dimensions may be uniform throughout the substructure 100A, 100B, 100C, with each wall having the same (uniform) dimensions throughout the framework 10.

In operation, the composite film including the functional auxetic structure is formed by spraying the polymer formulation (via a sprayer) onto the mold. The formulation may be sprayed continuously, being applied in passes to build up composite film to its desired thickness. That is, a first layer may be applied, followed by the application of the second layer prior to the first layer being fully cured. Each layer may be individually or a plurality of layers may be collectively via drying (at elevated or ambient temperature), light, etc. The composite film may be configured to be macroporous, microporous, nonporous, or a combination thereof. Once cured, the composite film may be separated from the mold.

The thickness of each layer in the composite film is selected based on final thickness of the completed structure, spray viscosity, etc. Each sprayed layer may possess the same thickness, or one or more layers in the composite may possess a different thickness. In an embodiment, 8-12 layers of polymer formulation (e.g., a polyurethane dispersion) are applied to the mold to form the composite film including an auxetic structure.

The final properties of the composite film 305 may be controlled via the spraying process. That is, by controlling spray intensity, droplet size, and surface tension, film thickness and film porosity may be controlled. This, in turn, enables controlling the porosity and breathability of the flock textile structure. Control of spray intensity is achieved by controlling spray gun movement speed relative to the carrier. The droplet size is controlled via, e.g., controlling the atomizing air pressure, changing the nozzle orifice diameter, and/or changing the viscosity polymer latex. The surface tension may be controlled by, e.g., controlling the chemical formulation. By way of example, a micro-porous layer generally results when droplet size is relatively large and when the surface tension is relatively high. This prevents drops from agglomerating—when drops are dispersed, pores in the film result. In general, the polymer latex is applied until the exposed portion of the flock fibers are encased in material.

It should be understood that multiple layers of polymer formulation may be applied while the underlying layer is uncured, or after partially or full curing of the underlying layer occurs.

With the above described process, a composite film possessing a functional topology is created. The functional structure is integrated into the composite film, i.e., the composite film is a unitary or monolithic (one piece) structure. Utilizing the in-mold coating process, the upper components display the grain, finish and shape of the mold. There is no loss in shape or shrink-back, which results in delamination. In addition, no stretching resulting in a loss of detail occurs.

Once formed, the composite film is incorporated into an article of footwear. That is, the mold may be configured to form a two-dimensional or three-dimensional form for the upper, which is then secured to a sole structure.

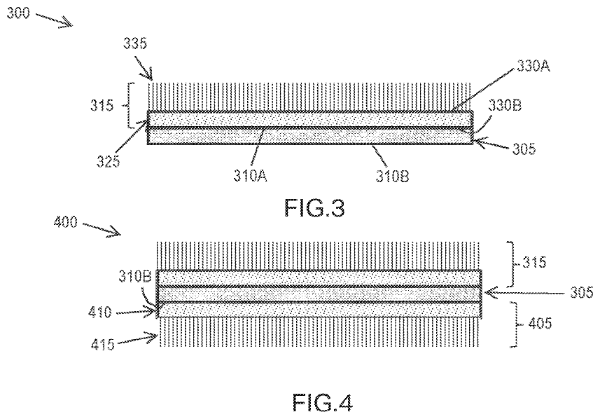

In an embodiment, upon formation of the composite film, a flock structure may further be applied to the film. Referring to embodiment of FIG. 3, the fabric material includes the composite film 305 including an auxetic structure defining a first surface 310A and an opposed second surface 310B, as well as a flock structure 315 including a base layer film 325 (defining a first surface 330A and an opposed second surface 330B) and a flock material layer 335. In an embodiment, the base layer film 325 is formed from a sprayable polymer formulation including polymer particles in solution. By way of example, the base layer polymer formulation may be latex formed via emulsion polymerization. In an embodiment, the polymer is a natural polymer emulsion such as latex rubber. In another embodiment, the polymer is a synthetic polymer such as a polyurethane emulsion or dispersion. The polymer dispersion may be the same or different from the polymer dispersion forming the composite film 305.

Once applied to the composite film 305, the formulation is cured via drying (at elevated or ambient temperature), light, etc. The resulting base layer film 325 is elastic, and may be configured to be macroporous, microporous, nonporous, or a combination thereof.

The flock material layer 335 is disposed on the first side 330A of the base layer film 325. The flock material may be any suitable for its described purpose. In general, flock is fragments of textile fibers. The flock material may be precision cut flock, where all fiber lengths are approximately equal, or random cut flock, where the fibers are ground or chopped to produce a broad range of lengths. A combination of flock types may also be utilized. The flock fibers may be formed of any material suitable for their described purpose. In general, the fibers forming the flock material are natural fibers such as cellulosic fibers (e.g., cotton, bamboo) or protein fibers (e.g., wool, silk, and soybean) and/or synthetic fibers formed of one or more types of polymers such as polyester, nylon, polypropylene, polyethylene, acrylics, acetate, polyacryonitrile, and combinations thereof.

The flock fibers, moreover, may be selected or modified/treated such that they possess one or more desired properties. By way of example, the flock fibers may be hydrophilic, hydrophobic, swellable, or a combination thereof. By way of specific examples, the flock fibers may include bicomponent fibers, polypropylene fibers, and polyester fibers that have been treated with surfactants; hydrophilic fibers such as rayon fibers, acrylic fibers, nylon fibers, polyvinyl alcohol fibers, and natural or regenerated cellulosics; and swellable fibers such as polyacrylate fibers, grafted cellulose fibers, and maleic acid fibers.

The fibers of the flock material may possess any denier and any length suitable for its described purpose. By way of example, the fibers of the flock material may possess a length of from approximately 0.1 millimeters to approximately 5 millimeters. Additionally, the fibers of the flock material may possess a denier of from approximately 0.5 to approximately 25. One suitable material for the flock material is a 1.5 denier nylon fiber having a length of approximately 0.5 millimeters.

The auxetic pattern of the composite film 305 is selected such that the expansion pattern of the auxetic film 305 drives the expansion of the flock structure 315 (and the resulting fabric structure). That is, the resulting fabric structure 300 including the composite film and flocking structure will possess auxetic properties, being capable of synclastic expansion. Stated another way, the resulting fabric structure 300 will possess a negative Poisson's ratio.

In an embodiment, this may be achieved be providing films of different thicknesses and/or by forming the auxetic layer (the open web) of a different material than the base layer 325. For example, the ratio of thickness of the composite film 305 including the auxetic structure to the flacking base layer film 325 may be 2:1. By way of specific example, if the composite film 305 is formed by eight layers of polymer formulation (eight passes), then the base film 325 is formed with four layers. It should be understood, however, other ratios are possible depending on the durometer values of each film. The critical feature is having the auxetic structure in the composite film dominate the flocked structure.

In other embodiments, the composite film may possess a different durometer than the polymer forming the base layer. Still further, the composite film may be formed of a polymer possessing a first modulus and the base layer may be formed of a polymer possessing a second modulus.

In operation, the composite film 305 including the auxetic structure is formed as described above. Optionally, the mold may be provided with a release coating to ensure separation of the composite film 305 from the mold. The base layer formulation 325 is then sprayed to the exposed side of the composite film 305 (e.g., the first side 310A) and the flock material 330 is applied to the uncured base layer. The base layer 325 is then cured to form the base film and thus the flock structure 315. It should understood that the base layer formulation may be applied to the composite layer 305 while the composite film is only partially cured.

In a further embodiment, the sprayed fabric structure includes flocking on both sides. Referring to FIG. 4, the fabric structure 400, in addition to first flock structure 315, further includes a second flock structure 405 disposed on the second side 310B of the composite film 305. As with first flock structure 315, the second flock structure 405 includes a base layer film 410 and a flock material layer 415. The base layer film 410 may be similar to that of the base layer film of the first flock structure 305. The flock material layer 415 may possess the same composition (fiber type, fiber size (denier and/or length), fiber density, fiber placement, etc.) as the first flock material layer 335. It should be understood, however, that the composition of the second base material layer 410 or the second flock material layer 410 may differ from those of the first flock structure 315.

In the method of forming the flock material, a carrier is provided. The carrier may be a two-dimensional object or may be three-dimensional object possessing a complex shape (e.g., the shape of the upper or shoe last). A temporary or release agent may be applied to a surface of the carrier. By way of example, the release agent may be water, an aqueous solution (e.g., including a surfactant), or an aqueous suspension (e.g., a hydrogel). The release agent is generally applied via spraying. The release agent may possess a viscosity sufficient to capture the flock fibers, securing them to the carrier in a predetermined position. The flock material layer 335 is applied to the uncured base layer 325. The flock application process includes electrostatic application, in which the flock fibers are applied in the presence of an electrostatic charge. The charge is effective to control the orientation of the flock fibers, aligning them to be generally orthogonal to the carrier surface. One end of each flock fiber penetrate the uncured polymer latex of the base layer, becoming secured in position on the carrier. In an embodiment, no more than about one-half of the length of the flock fiber becomes embedded in the uncured base layer 325.

After curing partially or fully, the composite film is applied as described above. The process continues, with the base layer 410 and flock material 415 of the second flock structure being applied to the composite film. The fabric 400 may then be cured via ambient temperature and pressure, or may be effectuated via heat or light. During this process, the release agent is typically evaporated.

The final properties of the composite film 305 and/or the base layer films 325, 410 may be controlled via the spraying process. That is, by controlling spray intensity, droplet size, and surface tension, film thickness and film porosity may be controlled. This, in turn, enables controlling the porosity and breathability of the flock textile structure. Control of spray intensity is achieved by controlling spray gun movement speed relative to the carrier. The droplet size is controlled via, e.g., controlling the atomizing air pressure, changing the nozzle orifice diameter, and/or changing the viscosity polymer latex. The surface tension may be controlled by, e.g., controlling the chemical formulation. By way of example, a micro-porous layer generally results when droplet size is relatively large and when the surface tension is relatively high. This prevents drops from agglomerating—when drops are dispersed, pores in the film result. In general, the polymer latex is applied until the exposed portion of the flock fibers are encased in material.

It should be understood that multiple layers of polymer latex may be applied while the underlying layer is uncured, or after partially or full curing of the underlying layer occurs.

The resulting flock fabric structure 300, 400 is incorporated into an upper. Alternatively, if the flock textile structure 300, 400 defines the entire footwear upper, it is coupled to a sole structure.

The above described invention provides footwear with excellent fit and feel. By altering such factors as flock density; polymer formulation; polymer layer thickness; and strand type, density and placement, it is possible control the degree of compression and resilience within the shoe, customizing the upper for its performance and comfort requirements. In addition, it is possible to form the fabric structure into the exact templates needed for shoe construction. This avoids the waste associated with the conventional cut and sew method, where the templates for the upper are cut from a large fabric sheet. It is, furthermore, possible to form the upper as a three dimensional structure (e.g., spraying directly onto a mold shaped as a last), rather than cutting multiple flat pieces together.

While the invention has been described in detail and with reference to specific embodiments thereof, it will be apparent to one skilled in the art that various changes and modifications can be made therein without departing from the spirit and scope thereof. For example, the mold 200 may be a two-dimensional object or may be three-dimensional object possessing a complex shape. By way of example, the mold may be a shoe last including the desired topology. By way of further example, the mold 200 may be a mold forming the negative of a shoe last (e.g. a mold possessing a cavity shaped as a portion of a shoe upper or of the entire upper). A temporary or release agent may be applied to a surface of the mold prior to application of the polymer formulation. By way of example, the release agent may be water, an aqueous solution (e.g., including a surfactant), or an aqueous suspension (e.g., a hydrogel). The release agent is generally applied via spraying.

Any of the indicated flock material layers and/or polymer layers may be omitted. Additionally, the polymer layer formulations may contain additives configured to provide the resulting layer with one or more desired properties (e.g. waterproofness). While electrostatic charge is discussed as a preferred means of applying and orienting the flock fibers, it should understood that other methods such as dusting and air-blasting may be utilized.

Thus, it is intended that the present invention covers the modifications and variations of this invention provided they come within the scope of the appended claims and their equivalents. It is to be understood that terms such as “top,” “bottom,” “front,” “rear,” “side,” “height,” “length,” “width,” “upper,” “lower,” “interior,” “exterior,” “medial,” “lateral,” and the like as may be used herein, merely describe points of reference and do not limit the present invention to any particular orientation or configuration.

What is claimed:

1. A method of forming a shoe upper, the method comprising:
obtaining a mold defining a shoe component;
spraying a polymer formulation onto the mold to form a sprayed polymer formulation layer, the polymer formulation include a plurality of polymer droplets in solution;
curing the sprayed polymer formulation layer to form a polymer film;
removing the film from the mold; and
incorporating the film into the shoe upper.

2. The method of claim 1, wherein spraying the polymer formulation comprises spraying a first coating of the polymer formulation and spraying a second coating of the polymer formulation on the first coating.

3. The method of claim 2, wherein the mold comprises an array of substructures defined by a network of channels.

4. The method of claim 3, wherein the array of substructures is an auxetic array operable to form a film capable of synclastic expansion.

5. The method of claim 4, further comprising forming a flock structure on the sprayed polymer formulation layer.

6. The method of claim 5, wherein forming the flock structure comprises:
spraying base layer onto the sprayed polymer formulation layer;
directing flocking material toward the base layer, the flocking material comprising a plurality of flocking fibers; and
orienting the flocking fibers in a predetermined orientation relative to the base layer.

7. A method of forming a shoe upper, the method comprising:
forming a fabric material by spraying one or more layers on a mold, wherein the fabric material comprises fibers at least partially embedded within the one or more layers of the formed fabric material, and the mold comprises an array of substructures that impart substructures to the fabric material; and
forming the shoe upper with the fabric material such that the substructures are provided on an outer surface of the fabric material.
